(19) United States
(12) Patent Application Publication
(10) Pub. No.: US 2013/0263706 A1
(43) Pub. Date: Oct. 10, 2013

(54) MULTI FORM SCREW DRIVER AND SCREW DRIVER BIT

(71) Applicant: JACOB S. SAFAR, SAN DIEGO, CA (US)

(72) Inventor: JACOB S. SAFAR, SAN DIEGO, CA (US)

(21) Appl. No.: 13/439,040

(22) Filed: Apr. 4, 2012

(51) Int. Cl. B25B 15/02; B25B 23/00

(52) U.S. Cl. 81/448

(57) ABSTRACT

Multi form screw driver and screw driver bit that fits on any screw head configuration and contains springs, a rubbery unit and micro-bit needles where the spring pushes the rubbery unit to form a tighter fit of the micro-bit-needles on the top surface of the screw such that the screw does not retract when pressure is applied.

### FIELD OF THE INVENTION

The present invention relates to the field of tools particularly relating to a screw driver. More particularly the present invention is a multi form screw driver that has an adaptable screw bit for various screw head configurations.

### BACKGROUND OF THE INVENTION

The screwdriver was invented in Germany in the late fifteenth century. Originally called a ‘screwturner,’ the first documentation of the tool is in “The Medieval Housebook of Wolfegg Castle”, published sometime between 1475 and 1490 AD. The original screwdriver had a pear-shaped handle and was made for slotted screws (Diversification of the many types of screwdrivers did not emerge until the Gilded Age). This time period roughly coincides with the appearance of the adjustable screw. The screwdriver remained inconspicuous, however, as evidence of its existence throughout the next 300 years was based primarily on the presence of screws.

Screws were used in the 15th century for constructing screw-cutting lathes, securing breastplates, backplates, and helmets on medieval jousting armor, and eventually for multiple parts of the emerging firearms, particularly the matchlock. Screws, hence screwdrivers, were not used in full combat armor, most likely to give the wearer freedom of movement.

The modern screwdriver descends directly from a flat-bladed bit used in a carpenter's brace circa 1750. Woodworkers were using hand screwdrivers in the early 1800s, and they became more common after 1850, when machines made the automatic production of screws possible. These early screwdrivers were flat throughout the length of their shaft; the current design of a rounded bar that is flattened or shaped only at the working end makes the tool much stronger and takes advantage of the round wire used in its manufacture. The oldest and most common type of screwdriver is the slotted screwdriver, which fits a screw with a single slot in the head.

One of the most popular new designs of the screwdriver was made by Canadian P. L. Robertson, who inadvertently invented the screwdriver when he patented the first socket-headed screw in 1907. There were large, heavy duty screwdrivers for building and repairing large machines, and more popular, smaller screwdrivers for refined cabinet work. There are perhaps thirty different types of screwdrivers available today in a variety of sizes, all with different purposes and all designed to fit into special screws.

A screwdriver tip should be of such shape and size as to fit the screw slot snugly. Failure to do this may result in damaging the screw slot to such an extent that the screw can be neither driven nor extracted.

Despite various improvements and progress in the field, a problem that still exists to effective use of screw drivers is that when trying to turn the screw, the screw driver edge may slip from the head of the screw when force applied injury to the person is likely to occur. A screwdriver tip of the wrong shape and size may also cause the tool to slip out of the screw slot and damage the work or some vital piece of equipment near by. When the downward, twisting pressure is applied to a screwdriver, there is no way of controlling the screwdriver if it should slip out of the screw slot.

Accordingly, improvements are needed in the existing tools that negate the above shortcomings in the existing tools.

The relevant prior art methods, which will deal with various innovations in screw drivers, are as follows:

United States Patent Publication No. 2003/0079581 provides a combination screwdriver and bit holder that provides the power tool to a bit holder for use with a drill chuck. The shaft adapted at one end for mounting to the handle and at the other end for releasing mounting tools bit. The storing bits in nested fashion around the shaft that shaft rotate in unison with handle. The present invention also provides storing bits comprises housing connected to shaft with bit compartments for releasable receiving tool bits. The handle mated with bit holder can be used as manual combination screwdriver.

United States Patent Publication No. 2006/0053986 claims a screw driver with bit storage cylinder. The base carries a positional hand grip. The present invention has the capability of storing a collection of bits. A cylinder rotatably mounted on the base having an array of bits for driving various types of headed fasteners. A base carries spindle imparts rotational movement to drive component and the drive tube. Magnetic components assist in positioning and retention of the screw driver bits.

United States Patent Publication No. 2008/0072718 describes a device for locking and releasing a screw bit. This invention provides locking a screw bits to a tube and releasing the screw bit out from the tube. A screw bit positioning device has a first hole and second hole through a wall. A first bead and second bead are respectively engaged to first and second holes. A movable member received in the passage and located between a stop and a first spring. A sleeve is movably mounted to the tube and cooperates with a second spring mounted on the tube. When the sleeve is moved, the first and second beads are pressed into the tube or received in two respective spaces in the inner periphery of the sleeve. The screw bit and the movable member are positioned when the first and second beads are merged into the tube. When the first and second beads are released, the screw bit is pushed out from the tube by the first spring.

United States Patent Publication No. 2010/0104397 discloses a screw and driver bit which has a screw having an improved recess for engaging with a driver bit that is generally depression-like and a driver bit. The loosening side sidewall in the distal end side portion bends at an oblique angle from the loosening side sidewall in the proximal end side portion away from the tightening side sidewall, if the driver bit of the second invention with blades of a shape complementary to that of the blade engaging portions is used, upon loosening the screw, the driver bit is hard to tilt relative to the axis of the screw by virtue of the mating of the bent loosening side sidewalls of the screw with the bent loosening side side-faces of the driver bit, and the loosening side sidewalls of the blade engaging portions bite into the loosening side side-faces of the blades, with the former having a shape bent according to the latter, ensuring that the side-faces securely grip the sidewalls and thereby the engagement between the blades and the blade engaging portions is improved.

United States Patent Publication No. 2002/0007705 provides a multi-bit driver that comprises a longitudinally oriented housing with a bit chuck at one end; a plurality of tool bits nested within housing in a retracted position; and bit assemblies having tool bits and being operable to extend said tool bit from said retracted position to said extended position by a single longitudinal motion for selectively extending tool bits to an extended position and retracting said tool bits to said retracted position, such that in the extended position, said tool bits project from said bit chuck and are substantially longitudinally aligned with said housing.

U.S. Pat. No. 6,330,844 provides a self-contained multi-use tool for a range of screws, nuts and bolts sized, consisting of various screw bit and adapter having holder and a nut driver set, which fit together in a decreasing order and can be stored in an increasing order on the back or inside of the handle. The socket member provides sufficient clearance to excess of length when working with extended rods or bolts. The screw bits and the adaptor can be stored on the holder or inside the opposite end of the handle.

U.S. Pat. No. 4,762,036 provides a screw driver that has a main body forming a handle at one end and a bit retaining heat at the other end. It has a plurality of bit storage locations radially positioned around head. A bit is provided for each storage location and a centrally located bit insert in the body is used to receive the inner end of a selected bit. A mechanically linked with each bit is used for sliding the bit from the storage location to the central bit insert.

U.S. Pat. No. 7,073,417 claims a combination screw driver and bit holder where the screwdriver has a handle and a detachable drill attachment for mounting onto a threaded output shaft of a power drill. The bit holder used in combination with a handle adapted at one end for releasably receiving bit holder, handle mated together with bit holder can be used as manual combination screwdriver.

U.S. Pat. No. 7,255,028 discloses a screwdriver having interchangeable bit bodies with permanently affixed bit heads is provided. A main body configured to hold at least two bit heads, a first bit head at a first end of the screwdriver and second bit head at a second end of the screwdriver; a first end cap covering the first bit head; and a second end cap covering the second bit head, wherein the first and second end caps are each configured to allow rotation between a first portion of the end cap and a second portion of the end cap. A user can apply pressure to an end cap top (whether nested or not) to stabilize the screwdriver for a particular job while rotating the screwdriver independent of the nesting cap top.

U.S. Pat. No. 7,757,589 claims a multi-bit, dual-mode screwdriver for either manual or powered actuation. When the screwdriver is in the manual rotation mode the body is adapted for hand gripping and torquing and the driveshaft opposite end receives a screwdriver bit. When the screwdriver is in powered rotation mode the driveshaft opposite end couples to powered rotation means such as a drill and the driveshaft body end receives the screwdriver bit. The driveshaft is adapted for coupling to a powered drill.

U.S. Pat. No. 5,799,552 claims a 13 in 1 multi-purpose screwdriver. This device has two decks. This device has a special feature of a locking deck to prevent the nut drivers and screwdriver bits from falling out. The locking deck has a special feature of being locked in place by just the push of a button. The nut drivers are in a movable platform which slide up and down the hexagon shaft of the screwdriver. The key to this device lies in the top lock deck: the notched dowel pin fits snuggly into the matching notch on the hex shaft.

U.S. Pat. No. 4,890,521 discloses a self-gripping power screw driver bit. A bit for a power-operated screw driver formed with a square cross section driver end and a shank end aligned on a central axis, said bit driver end portion for use with a screw having a combined socket that accepts the driver of either a square-sectioned bit or a cross-point bit. Each halved element driver portion defines a trapezoidal cross section having major and minor parallel exterior side surfaces, a complete side surface extending at right angles to its major and minor surfaces, and a diagonal-like interface. In opposed flush contact defining said axially extending oblique plane which includes the principal axes of both said composite bit and the screw driver bit holder. The halved elements slip along their interfaces expanding the bit complete side surfaces in opposite directions and wedgingly engage their associated opposed recess faces thereby positively holding said composite bit driver end portions in the screw combined socket obviating slippage of said composite bit driver end portions from the screw combined socket.

However the purpose and methodology of all the above inventions that are part of prior art do not envisage the unique embodiment of a screw driver containing a multi screw bit that has special features to ensure a snug fit on the screw head and reduce the torque in the screw turning or other motion.

Thus it is clear that it is desirable to provide a multi form screw driver and screw driver bit that is capable of overcoming these disadvantages in the prior art. The present invention overcomes these and other problems by providing a multiform screw driver and a screw bit that fits on any screw-head configuration through the presence of a locking mechanism consisting of micro-bit needles which lock in position onto the screw head such that the screws do not retract or alter position when pressure is applied.

Further it will be apparent to those skilled in the art that the objects of this invention have been achieved by providing a multi form screw driver and screw driver bit invention that is adaptable for various screw head configurations. Various changes may be made in and without departing from the concept of the invention. Further, features of some stages disclosed in this application may be employed with features of other stages. Therefore, the scope of the invention is to be determined by the terminology of the following description, claims, drawings and the legal equivalents thereof.

### SUMMARY OF THE INVENTION

This present invention may be summarized, at least in part, with reference to its objects.

It is therefore a primary objective of the present invention to provide a multi form screw driver and screw driver bit that reduces the torque in the screw turning or other motion.

Another objective of the present invention is to provide a multi form screw driver and screw driver bit that provides an easy grip and comfort to use.

Another objective of the present invention is to provide a multi form screw driver and screw driver bit that eliminates the need to have different screw driver, or screw driver bits, to drive screw heads of different configuration.

A further objective of the present invention is to provide a multi form screw driver and screw driver bit that ensures a snug fit on the screw head such that the screw does not retract or later its position when pressure is applied.

The invention described herein thus comprises a multi form screw driver and screw driver bit that contains micro-bit-needles and a manual micro-bit needle locking mechanism where during the screw driving process, the turning of the screw driver handle by the user activates a series of parts to bring the micro-bit needle heads into contact with the screw head, and thereafter use the manual micro-bit-needle locking mechanism to lock the micro-bit-needles in position on the screw head when driving the screw head into the screw hole.

The above summary is intended to illustrate exemplary embodiments of the invention, which will be best understood in conjunction with the detailed description to follow, and are not intended to limit the scope of the invention. Additional objects and embodiments of the invention will be set forth in part in the description which follows, and in part will become apparent to those skilled in the art upon examination of the following, or may be learned by practice of the invention. Thus these and other objects of the present invention will be more readily apparent when considered in reference to the following description and when taken in conjunction with the accompanying drawings.

### DESCRIPTION OF THE DRAWINGS

FIG. 1 is a cross sectional diagram showing the parts of the present invention.

### DETAILED DESCRIPTION OF THE INVENTION

The following description is presented to enable any person skilled in the art to make and use the invention, and is provided in the context of particular applications of the invention and their requirements.

The present invention may involve arrangement of parts to implement the said invention. For example, although a series of arrangement of parts may be described with reference to a diagram, the order of arrangement of parts may differ in other implementations when the position of one part is not dependent on the position of another part. Further, non-dependent parts may be arranged in parallel. Thus, the present invention is not intended to be limited to the embodiments shown.

The present invention can be configured as follows:

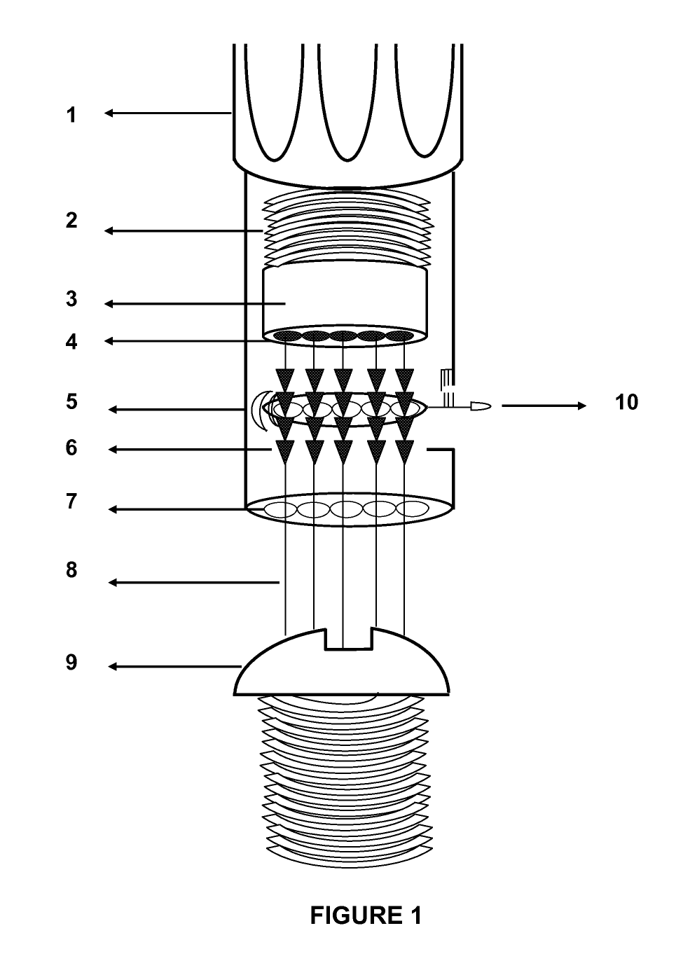

As illustrated in FIG. 1. the present invention consists of a multiform screw driver and screw driver bit comprising of a screw driver handle (1), a spring (2), a rubbery unit (3), micro-bit needles (11) that includes the micro-bit needle end (4), micro-bit needle surface (6) and micro-bit needle head (8), a plate (7) containing openings corresponding to the micro-bit-needles. The invention further contains a locking mechanism spring (5), and a manual micro-bit needle locking mechanism (10).

In a preferred embodiment of the present invention, during the screw driving process, a downward pressure is applied by the user to the screw driver handle (1), twisting the user hand at the wrist in a clockwise direction. The screw driver handle (1) is thus turned clockwise to activate the spring (2) which in turn pushes the rubbery unit (3). The rubbery unit (3) material has memory and can go back to its original size and form once the pressure applied by the spring (2) is removed.

According to another embodiment of the present invention, the downward motion of the rubbery unit (3) activates the locking mechanism spring (5) and one directional micro-bit needles (11) that include the micro-bit needle end (4), micro-bit needle surface (6) and micro-bit needle head (8). The micro-bit needle end (4) is attached to the rubbery unit (3). The micro-bit needle surface (6) is made of smooth pressure resistant material including but not limited to . . . .

According to another embodiment of the present invention, the micro-bit needle heads (8) comes out through the corresponding opening on the plate (7). This keeps the micro-bit needles (11) uniformly spaced and aligned and prevents any direct contact between each micro-bit needle (11), thus avoiding wear and tear or jeopardizing the contact with the screw head (9). The micro-bit needle heads (8) are smooth and come into contact with the screw head (9) during the screw driving process. After this the manual micro-bit-needle locking mechanism (10) can be used to lock the micro-bit-needles (11) in position on the screw head (9) so that they do not retract when pressure is applied during the screw driving process.

The present invention helps obtain a tighter fit of the multiform screw driver and screw driver bit on the top surface of the screw head (9) through the use of the micro-bit-needles (11). There is no requirement to have different screw drivers, or screw driver bits, to drive different screw heads. With a single screwdriver any screw-head configuration can be threaded into a screw hole.

The screw driver handle (1) of the present invention provides an easy grip comfort and facilitates the reduction of torque thus enabling a screw driving process with minimum effort

Again it is common for the screw driver blade to shift in position with relation to the center of the screw head slot and the axis of the screw and result in its slipping out of the screw head slot. If the screwdriver should slip it is likely to do severe damage to the user's hand and also the screw. The present invention protects against such slipping out of the screw driver from the screw head slot.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth.

Further it will be apparent to those skilled in the art that the objects of this invention have been achieved by providing the above invention. However various changes may be made in the structure of the invention without departing from the concept of the invention. Therefore, the scope of the invention is to be determined by the terminology of the above description and the legal equivalents thereof.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

I claim:

1. A multi form screw driver and screw driver bit comprising:
a screw driver handle (1);
a spring (2);
a rubbery unit (3);
micro-bit needles (11);
a plate (7) containing openings corresponding to the micro-bit-needles;
a locking mechanism spring (5);
a manual micro-bit needle locking mechanism (10);
characterized in that each micro-bit needle (11) contains a micro-bit needle end (4), a micro-bit needle surface (6) and a micro-bit needle head (8), the micro-bit needle end (4) being attached to the rubbery unit (3).

2. The multi form screw driver and screw driver bit as claimed in claim 1 and working thereof wherein during the screw driving process, a downward pressure is applied by the user holding the screw driver handle (1), twists his hand at the wrist in a clockwise direction, turning the screw driver handle (1) clockwise to activate and compress the spring (2).

3. The multi form screw driver and screw driver bit as claimed in claim 1 and working thereof wherein the compressed spring (2) pushes the rubbery unit (3) downward.

4. The multi form screw driver and screw driver bit as claimed in claim 1 and working thereof wherein the downward motion of the rubbery unit (3) activates the locking mechanism spring (5) and pushed the micro-bit needles (11) downward.

5. The multi form screw driver and screw driver bit as claimed in claim 1 and working thereof wherein the micro-bit needle heads (8) enters the corresponding opening on the plate (7) and comes out through the other side of the plate (7), and come into contact with the screw head (9).

6. The multi form screw driver and screw driver bit as claimed in claim 1 and working thereof wherein the manual micro-bit-needle locking mechanism (10) locks the micro-bit-needles (11) in position on the screw head (9) when driving the screw head (9) into the screw hole.

7. The multi form screw driver and screw driver bit as claimed in claim 1 and working thereof wherein after the screw driving process, on releasing the downward pressure on the screw driver handle (1), the compressed spring returns to its original state, the pressure applied by the spring (2) is removed and the rubbery unit (3) material returns to its original size and form.

8. The multi form screw driver and screw driver bit as claimed in claim 1 wherein the micro-bit needle surface (6) is made of smooth pressure resistant material including but not limited to . . . .
